(19) United States
(12) Patent Application Publication
(10) Pub. No.: US 2011/0179590 A1
(43) Pub. Date: Jul. 28, 2011

(54) Swimming Pool Cleaners, and Associated Hoses and Connectors for Use with the Same

(76) Inventor: David Andrew Klimas, Ramona, CA (US)

(21) Appl. No.: 12/695,454

(22) Filed: Jan. 28, 2010

(51) Int. Cl. E04H 4/16; F16L 11/00

(52) U.S. Cl. 15/1.7; 138/120

(57) ABSTRACT

Swimming pool cleaners, and associated hoses and connectors used with swimming pool cleaners may include a lock mechanism for releasably locking multiple hose segments or other components together in varying, discrete locked positions, such that a user can adjust the connection between the components to obtain a fluid tight joint. In these or other embodiments, one or both components can include an improved sealing structure that may facilitate forming such a fluid tight joint.

### RELATED FIELDS

This invention relates principally, but not necessarily exclusively, to swimming pool cleaners, and associated hoses and connectors used with swimming pool cleaners.

### BACKGROUND

Swimming pool cleaners can include automatic and non-automatic types of pool cleaners, and also suction type and non-suction type pool cleaners. FIG. 1 schematically shows an automatic, suction type pool cleaner 16. The pool cleaner 16 shown in FIG. 1 includes a pool cleaner head 18, which has a suction pad 20 for interfacing with a substrate or a surface to be cleaned, such as the walls 12 of the pool 10. The pool cleaner 16 of FIG. 1 also includes a hose assembly 22 for directing water from below the suction pad 20 to an inlet of the pool's circulation and filtration system or another destination.

Often, although not always, the hose assembly 22 is formed from several hose segments 24. In some uses, the hose assembly 22 is formed from several hose segments 24 so that the hose segments 24 can be kept straight during shipping, storing and at other times. In some uses, it is undesirable to coil hose assemblies used with pool cleaners, as it occasionally can cause the hose to retain a curved shape that could, in some uses, degrade performance of the pool cleaner.

The hose segments 24 may be connected together by inserting an end of one of the hose segments into an end of another hose segment. The ends of the hose segments may include “cuffs,” such as “male hose cuffs” and “female hose cuffs,” the male hose cuff fitting into the female hose cuff to connect the two hose segments. For known hoses used with pool cleaners, the closeness of the fit between the hose cuffs, particularly the outer diameter of the male hose cuff and the inner diameter of the female hose cuff, can effect the tightness of the connection between the two hose segments as well as whether and to what extent the connection between the two hose segments is fluid tight. If the hose cuffs are not manufactured to exacting tolerances, the hose segments will not always be capable of forming a strong or fluid tight connection, which, in some instances, may degrade the performance of the pool cleaner and otherwise make the pool cleaner more difficult to set up and use. For instance, in some, although not necessarily all, uses, portions of the hose assembly will float on the surface of the pool, and if a tight seal is not present between the hose segments, air can be introduced into the interior of the hose, which, in some uses, can degrade the performance of the pool's circulation system or other components.

### SUMMARY

We have developed improved connectors for use with pool cleaner hoses and other components, such as the components on the pool cleaner head used to connect a hose to the cleaner head. In some embodiments, the hose segments are releasably locked together in a manner that facilitates a fluid tight seal between the components. In some embodiments, the hose segments are releasably locked together by inserting an end of one of the hose segments into an end of the other hose segment. In such embodiments, the hose segments may be releasably locked together in two or more discrete positions, and adjusting the lock from one discrete position to another discrete position may cause the inserted hose segment to insert further into the other hose segment in which it is inserted, which, in some embodiments, may tighten the seal between the two hose segments.

In some embodiments, one or both ends of the hose segment includes a sealing structure positioned in an interior area of the hose segment. The sealing structure may be positioned to contact an end of the other hose segment when the other hose segment is inserted into the interior area of the first hose segment. In some embodiments, such a sealing structure may supplement, partially replace or entirely replace the need for a tight fit between, for example, the outer diameter of a male hose cuff with the inner diameter of a female hose cuff, in order to form a fluid tight seal between the hose segments or other components.

In some embodiments, adjusting a locking mechanism of the hose segments from one discrete position to another discrete position may cause the inserted hose segment to insert further into the other hose segment such that the inserted hose segment will come into contact with, or further into contact with, the seal structure of the other hose segment or component, tightening the seal between the two hose segments.

### BRIEF DESCRIPTION OF THE DRAWINGS

FIG. 1 schematically illustrates a pool and an automatic pool cleaner.

FIG. 2 illustrates portions of two hose segments.

FIG. 3 illustrates a cross-section of a female hose cuff of one of the hose segments shown in FIG. 2.

FIG. 4 illustrates a cross-section of a male hose cuff of one of the hose segments shown in FIG. 2.

FIG. 5 illustrates the male hose cuff of FIG. 4 inserted into the female hose cuff of FIG. 3.

FIGS. 6a-6c illustrate the two hose segments of FIG. 2 locked together in various positions.

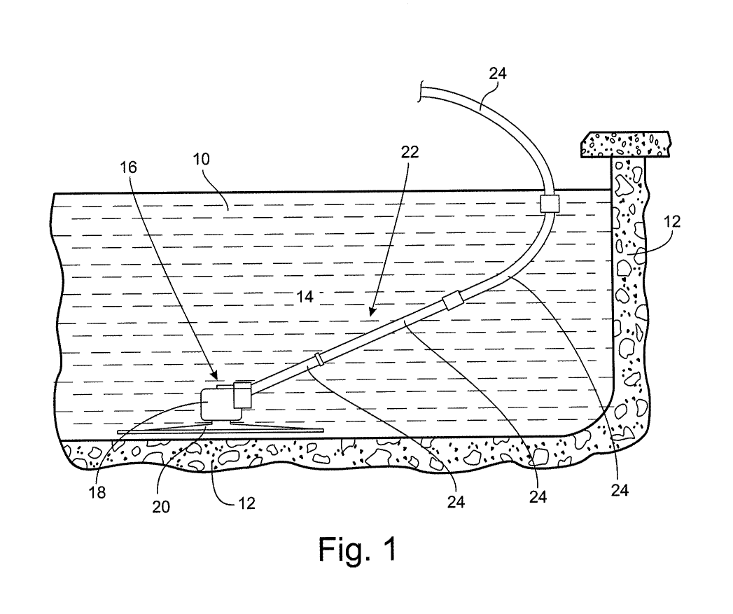

### DETAILED DESCRIPTION OF THE DRAWINGS

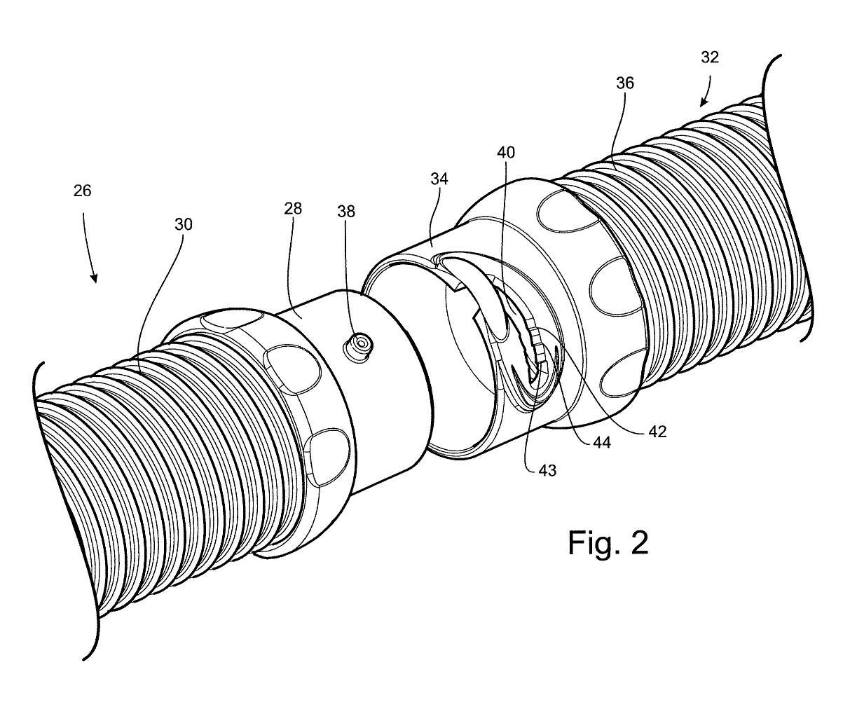

FIG. 2 shows portions of a first pool cleaner hose segment 26 having a first end 28 associated with a hose body 30 and a second pool cleaner hose segment 32 having a second end 34 associated with a hose body 36. In the embodiment shown in FIG. 2, the first end of the first hose segment 26 includes a male hose cuff 28 that fits inside a female hose cuff 34 of the second end of the second hose segment 32 to couple the two hose segments together, although, in other embodiments, other structures, devices or materials other than hose cuffs can be used to couple the two hose segments 26 and 32 together.

The male hose cuff 28 and female hose cuff 34 are generally cylindrical in shape and define passageways through which fluid can pass into the associated hose bodies 30 and 36. The outer diameter of the cylindrical male hose cuff 28 is at least slightly smaller than the inner diameter of the cylindrical female hose cuff 34, such that the male hose cuff 28 can fit into the female hose cuff 34 to connect the two hose segments 26 and 32 together. In other embodiments, the male and female hose cuffs 28 and 34 could have other geometries that allow the two hose segments to be connected together. In still other embodiments, male and female hose cuffs are not necessary, and other structures, including separable structures attached to the ends of the hose segments, structures formed integrally on the ends of the hose segments, or the ends of the hose segments themselves can be used to connect the hose segments.

The hose cuffs 28 and 34 shown in FIG. 2 include locking features that facilitate locking hose segments 26 and 32 together. In the specific embodiment illustrated by FIG. 2, the male hose cuff includes a post 38 that slides into a groove 40 formed in the female hose cuff to lock the hose segments together. As shown, the groove 40 curves or turns as it extends through the female hose cuff 34, such that twisting one hose segment with respect to the other moves the post 38 towards a distal end of the groove 40, locking the hose segments together. In other embodiments, the exact structure and function of the locking features is not important, and other arrangements can be utilized to lock the hose segments together. For instance, in some embodiments, the female hose cuff may include one or more posts having the same or different geometries of the post 38 shown in FIG. 2 and the male hose cuff may include one or more grooves having the same or different geometries of the groove 40 shown in FIG. 2. In still other embodiments, the hose segments may include other types of locking features, such as ratcheting mechanisms, screw threads, snap features, or other features that facilitate locking the two hose segments together.

In the embodiment shown in FIG. 2, because the groove 40 is at least somewhat curved, and curves away from the end of the female hose cuff 34, the male hose cuff 28 will move further into the female hose cuff 34 as the hose cuffs 28 and 34 are twisted with respect to one another to move the post 38 towards the distal end of the groove 40. However, in other embodiments, other groove geometries could be employed to cause the male hose cuff 28 to move further into the female hose cuff 34 as they are twisted. For instance, without limitation, the female hose cuff could include a straight groove extending away from the end of the female hose cuff in a non-perpendicular, slanted angle that could interact with an appropriately sized and placed post on the male hose cuff to cause the male hose cuff to move further into the female hose cuff as they are twisted together.

The groove 40 shown in FIG. 2 includes several pairs of restrictions 42, 44 and 46 that intermittently narrow the width of the groove 40. In some embodiments, the width of the groove 40 at the restrictions 42, 44 and 46 is at least somewhat narrower than the width of the post 38 on the male hose cuff 28, and, as such, the restrictions 42, 44 and 46 will at least somewhat limit the movement of the post 38 through the groove 40. In the embodiment illustrated by the Figures, although the restrictions 42, 44 and 46 at least somewhat limit the movement of the post 38 through the groove 40, application of a sufficient twisting force will allow the post 38 to move past a pair of restrictions. For instance, in some embodiments, the geometry and material of the restrictions in the groove, and/or the geometry and material of the post may cause those structures to be at least somewhat resilient in shape, such that application of a sufficient force will temporarily deform those structures, allowing the post to move past the restrictions. In some embodiments, the restrictions do not need to be formed in pairs, and a series of single restrictions along the length of the groove 40 will be sufficient to define narrower width portions of the groove.

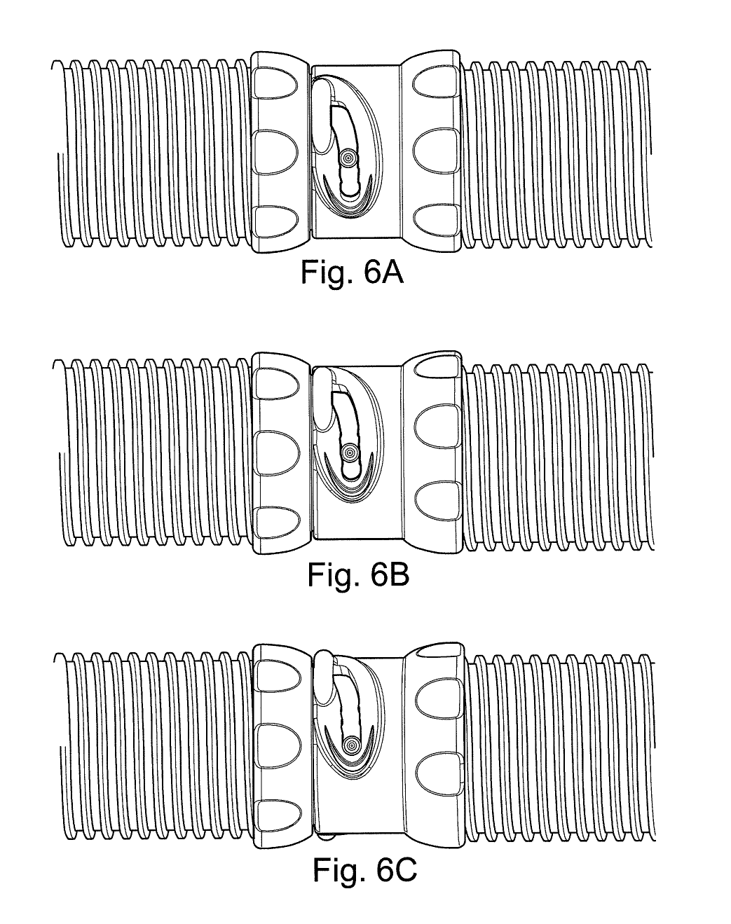

In the embodiment shown in the Figures, because there are multiple pairs of restrictions 42, 44 and 46 in the groove 40, there are several discrete locking positions in which the male and female hose cuffs 28 and 34 may be locked together. Accordingly, FIG. 6a shows a first locked position (with the post positioned between the first and second pairs of restrictions 42 and 44), FIG. 6b shows a second locked position (with the post 40 positioned between the second and third pairs of restrictions 44 and 46), and FIG. 6c shows a third locked position (with the post 40 positioned past the third pair of restrictions 46 at the distal end of the groove 40). As described above, moving the post 38 towards the distal end of the groove 40 (e.g. moving from the first locked position, to the second and/or third locked positions) will cause the male hose cuff 28 to move further into the female hose cuff 34.

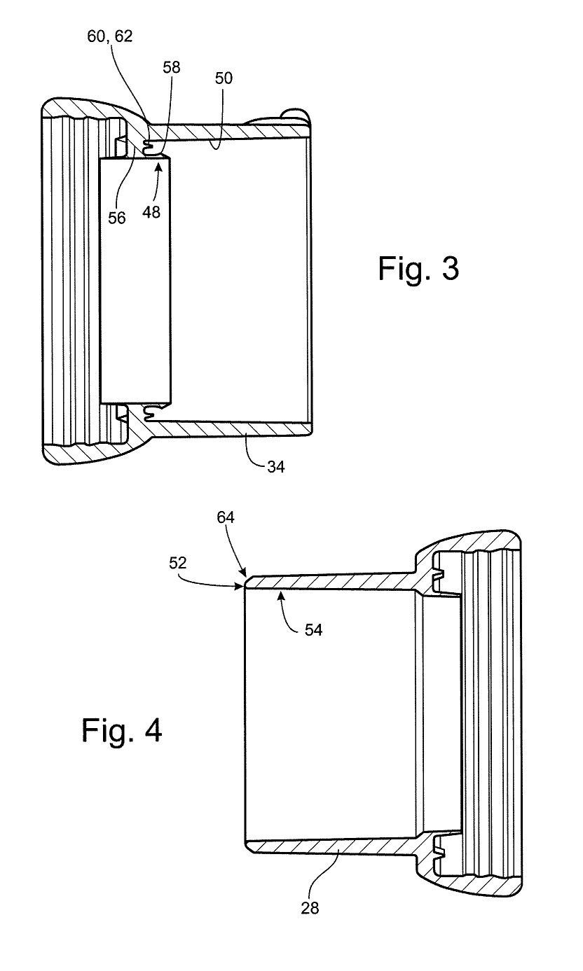

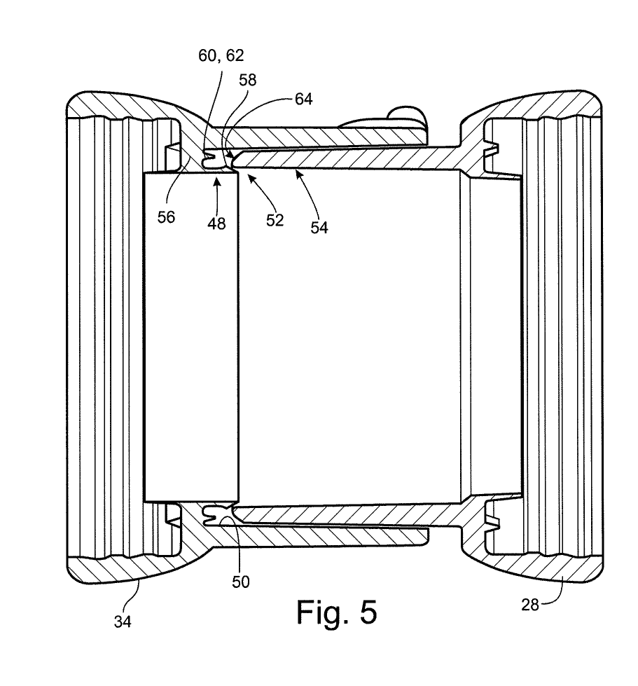

FIGS. 3-5 show cross sections of the female hose cuff 34 (FIG. 3), the male hose cuff 28 (FIG. 4), and the male hose cuff 28 inserted into the female hose cuff 34 (FIG. 5). In some embodiments, the cuffs are made by injection molding, although other manufacturing processes could also be used. The cuffs may be made from rigid plastic, flexible plastic, a combination of rigid and flexible plastics, or from other materials. In some embodiments, some portions of the cuff could be made from rigid plastic and other portions of the cuff could be over-molded with a less rigid plastic.

As shown in FIG. 3, the female hose cuff 34 includes a seal 48 positioned in an interior area of the female hose cuff 34. In some embodiments, the seal 48 is positioned in the interior of the female hose cuff 34 such that when the male hose cuff 28 is inserted into the female hose cuff 34, the seal 48 will interact with the distal end 52 of the male hose cuff 28 to form a relatively fluid tight connection. In some embodiments, the seal 48 is in addition to, or instead of, any sealing effect provided by the interaction between the outer surface of the male hose cuff 28 and the inner surface of the female hose cuff 34. In some embodiments, the seal 48 could be associated with the male hose cuff 28 rather than the female hose cuff 34.

In the particular embodiment shown in FIGS. 3-5, the seal 48 is positioned in the interior area of the female hose cuff 34 to define a space between itself and the interior surface 50 of the female hose cuff 34, such that the seal 48 is positioned to contact a distal end 52 of the male hose cuff 28, as shown in FIG. 5. As shown in FIG. 5, the seal 48 is positioned such that at least a portion of the distal end 52 of the male hose cuff 28 can fit in the space between the interior surface 50 of the female hose cuff 34 and the seal 48, such that the seal 48 contacts an interior surface 54 of the male hose cuff 34. In other embodiments, the seal is positioned to contact other portions of the male hose cuff 28.

In some embodiments, the seal 48 may be at least somewhat resilient, such that it will flex slightly as the distal end 52 of the male hose cuff 28 enters the space between the seal 48 and the interior surface 50 of the female hose cuff 34, yet will tend to remain in contact with the interior surface 54 of the male hose cuff 34. In the particular embodiment shown in FIGS. 3 and 5, the seal 50 includes a rib 58, which may further facilitate maintaining contact between the seal 50 and the distal end 52 of the male hose cuff 28.

In the particular embodiment shown in FIGS. 3-5, the seal 48 is supported in the interior area of the female hose cuff 34 by a flange 56 extending from the interior surface 50 of the female hose cuff 34. In other embodiments, however, the seal 48 may be directly connected to the interior surface 50 of the female hose cuff 34 or could be positioned in the interior area of the female hose cuff in other manners.

The flange 56 shown in FIGS. 3 and 5 also includes a wedge 60 extending outwardly from it into the space between the seal 48 and the interior surface 50 of the female hose cuff 34. The wedge 60 includes a ramped surface 62, which, in the particular embodiment shown in FIGS. 3-5, is positioned to interact with a chamfered surface 64 on the male hose cuff 28, such that as the distal end 52 of the male hose cuff 28 enters or moves further into the space between the seal 48 and the interior surface 50 of the female hose cuff 34, the interior surface 54 of the male hose cuff 28 will be forced into contact with, or more tightly in contact with, the seal 48. For instance, in the embodiment shown in FIGS. 6a-6c, as the hose segments are connected and adjusted through the discrete locking positions defined by the first, second and third restrictions 42, 44 and 46, the distal end 52 of the male hose cuff 28 may be forced into contact with, or more tightly in contact with the seal 48 by the interaction of the ramped surface 62 and the chamfered surface 64, which may tighten the seal between the two hose segments.

Some of the above described embodiments may be advantageous in that hose segments or other pool cleaner components may not require exacting manufacturing tolerances to obtain a tight seal in all situations. The examples provided above are only a few particular embodiments of the invention, with a few alternatives noted. One of skill in the art will recognize that other alternatives will be possible, and that the above description is offered as one example only, and is not intended to be limiting on the scope of the present invention, which is described in the following claims.

We claim:

1. A pool cleaner hose assembly, the assembly comprising:
a. a first pool cleaner hose segment, having a first end;
b. a second pool cleaner hose segment, having a second end;
c. wherein a portion of the first end of the first pool cleaner hose segment is inserted inside of a portion of the second end of the second pool cleaner hose segment; and
d. wherein a seal associated with the second end of the second pool cleaner hose segment contacts an interior surface of the distal end of the portion of the first end of the first pool cleaner hose segment inserted into the portion of the second end of the second pool cleaner hose segment.

2. The pool cleaner hose assembly of claim 1, further comprising a lock that releasably locks the first and second pool cleaner hose segments together when the portion of the first end of the first pool cleaner hose segment is inserted inside the portion of the second end of the second pool cleaner hose segment.

3. The pool cleaner hose assembly of claim 2, wherein the lock further comprises a first locked position and a second locked position.

4. The pool cleaner hose assembly of claim 3, wherein moving the lock from the first locked position to the second locked position causes the first pool cleaner hose segment to insert further inside of the portion of the second end of the second pool cleaner hose segment.

5. The pool cleaner hose assembly of claim 4, wherein moving the lock from the first locked position to the second locked position causes the portion of the first end of the first pool cleaner hose segment to move into or further into a space between an interior surface of the second end of the second pool cleaner hose segment and the seal.

6. The pool cleaner hose assembly of claim 5, wherein moving the lock from the first locked position to the second locked position causes a chamfered surface on the distal end of the first end of the first pool cleaner hose segment to contact or further contact a ramped surface associated with the second end of the second pool cleaner hose segment, the ramped surface positioned between the interior surface of the second end of the second pool cleaner hose segment and the seal.

7. The pool cleaner hose assembly of claim 1, wherein the distal end of the portion of the first end of the first pool cleaner hose segment is inserted between an interior surface of the second end of the second pool cleaner hose segment and the seal.

8. The pool cleaner hose assembly of claim 7, further comprising a ramped surface associated with the second end of the second pool cleaner hose segment positioned between the interior surface of the second end of the second pool cleaner hose segment and the seal.

9. The pool cleaner hose assembly of claim 8, wherein the ramped surface contacts a chamfered surface on the distal end of the first end of the first pool cleaner hose segment when the portion of the first end of the first pool cleaner hose segment is inserted inside the portion of the second end of the second pool cleaner hose segment.

10. A pool cleaner hose assembly, the assembly comprising:
a. a first pool cleaner hose segment, having a first end;
b. a second pool cleaner hose segment, having a second end;
c. wherein a portion of the first end of the first pool cleaner hose segment is inserted inside of a portion of the second end of the second pool cleaner hose segment; and
d. wherein a seal associated with the second end of the second pool cleaner hose segment contacts the distal end of the portion of the first end of the first pool cleaner hose segment inserted into the portion of the second end of the second pool cleaner hose segment; and
e. wherein the distal end of the portion of the first end of the first pool cleaner hose segment is inserted between an interior surface of the second end of the second pool cleaner hose segment and the seal.

11. The pool cleaner hose assembly of claim 10, wherein the seal contacts an interior surface of the distal end of the portion of the first end of the first pool cleaner hose segment.

12. The pool cleaner hose assembly of claim 11, further comprising a ramped surface associated with the second end of the second pool cleaner hose segment positioned between the interior surface of the second end of the second pool cleaner hose segment and the seal.

13. The pool cleaner hose assembly of claim 12, wherein the ramped surface contacts a chamfered surface on the distal end of the first end of the first pool cleaner hose segment when the portion of the first end of the first pool cleaner hose segment is inserted inside the portion of the second end of the second pool cleaner hose segment.

14. A pool cleaner hose segment for use in a pool, the hose segment comprising:
a. a pool cleaner hose body having first and second ends; and
b. a seal, wherein the seal is positioned proximate one of the first and second ends and extends into an interior area of the hose body.

15. The pool cleaner hose segment of claim 14, wherein the seal and an interior wall of the hose body define a space between the interior wall and the seal.

16. The pool cleaner hose segment of claim 15, further comprising a ramped surface positioned between the interior wall and the seal.

17. The pool cleaner hose segment of claim 15, further comprising a wedge extending into the space between the interior wall and the seal, the wedge defining a ramped surface.

18. The pool cleaner hose segment of claim 17, wherein the first end of the hose body comprises a cuff and the seal is positioned in an interior area of the cuff.

19. The pool cleaner hose segment of claim 18, further comprising a flange extending from the interior wall, wherein the seal extends from the flange.

20. The pool cleaner hose segment of claim 19, wherein the wedge extends from the flange, between the seal and the interior wall.

21. A pool cleaner hose assembly for use in a pool, the assembly comprising:
a. a first pool cleaner hose segment, the first pool cleaner hose segment having a first end;
b. a second pool cleaner hose segment, the second hose segment having a second end;
c. wherein a portion of the first end of the first pool cleaner hose segment is inserted inside of a portion of the second end of the second pool cleaner hose segment; and
d. a lock that releasably locks the first and second pool cleaner hose segments together when the portion of the first end of the first pool cleaner hose segment is inserted inside of the portion of the second end of the second pool cleaner hose segment, the lock further comprising a first locked position and a second locked position.

22. The pool cleaner hose assembly of claim 21, wherein moving the lock from the first locked position to the second locked position causes the portion of the first end of the first pool cleaner hose segment to insert further inside of the portion of the second end of the second pool cleaner hose segment.

23. The pool cleaner hose assembly of claim 22, wherein moving the lock from the first locked position to the second locked position causes the portion of the first end of the first pool cleaner hose segment to move into or further into a space between an interior surface of the second end of the second pool cleaner hose segment and a seal associated with the second end of the second pool cleaner hose segment.

24. The pool cleaner hose assembly of claim 23, wherein moving the lock from the first locked position to the second locked position causes a chamfered surface on the first end of the first pool cleaner hose segment to contact or further contact a ramped surface associated with the second end of the second pool cleaner hose segment, the ramped surface positioned between the interior surface of the second end of the second pool cleaner hose segment and the seal.

25. The pool cleaner hose assembly of claim 24, wherein the seal contacts an interior surface of the first end of the first pool cleaner hose segment.

26. The pool cleaner hose assembly of claim 22, wherein the lock comprises a post extending from one of the first end of the first pool cleaner hose segment or the second end of the second pool cleaner hose segment and a groove extending at least partially through the other of the first end of the first pool cleaner hose segment or the second end of the second pool cleaner hose segment.

27. The pool cleaner hose assembly of claim 26, wherein the groove extending at least partially through the other of the first end of the first pool cleaner hose segment or the second end of the second pool cleaner hose segment is at least slightly curved.

28. The pool cleaner hose assembly of claim 26, wherein the groove includes a first portion of reduced width and a second portion of reduced width.

29. The pool cleaner hose assembly of claim 28, wherein in the first locked position, the post is positioned in the groove between the first portion of reduced width and the second portion of reduced with; and wherein in the second locked position, the post is positioned in the groove between the second portion of reduced width and a distal end of the groove.

30. A pool-cleaning system comprising:
a. an automatic pool cleaner; and
b. a first suction-hose segment;
c. wherein the automatic pool cleaner is connected to the first suction-hose segment by a first connector and a second connector:
i. the first connector having a first end;
ii. the second connector having a second end;
iii. wherein a portion of the first end is inserted inside of a portion of the second end; and
iv. wherein a lock releasably locks the first and second connectors together when the portion of the first end of the first connector is inserted inside of the portion of the second end of the second connector, the lock further comprising a first locked position and a second locked position.

31. The pool cleaner hose assembly of claim 30, wherein moving the lock from the first locked position to the second locked position causes the portion of the first end of the first pool cleaner hose segment to insert further inside of the portion of the second end of the second pool cleaner hose segment.
